(19) United States
(12) Patent Application Publication
(10) Pub. No.: US 2017/0348898 A1
(43) Pub. Date: Dec. 7, 2017

(54) RESIN MEMBER PRODUCTION METHOD

(71) Applicant: JTEKT CORPORATION, Osaka-shi, Osaka (JP)

(72) Inventor: Toru KAMIYA, Kashiwara-shi (JP)

(73) Assignee: JTEKT CORPORATION, Osaka-shi, Osaka (JP)

(21) Appl. No.: 15/538,603

(22) PCT Filed: Dec. 22, 2015
(86) PCT No.: PCT/JP2015/085767

§ 371 Date: Jun. 21, 2017

(30) Foreign Application Priority Data
Dec. 24, 2014 (JP) 2014-260519
Oct. 16, 2015 (JP) 2015-204837

(51) Int. Cl. B29C 59/14; F16C 33/44; B29L 31/04; F16C 19/06; B29K 77/00

(52) U.S. Cl. CPC B29C 59/14; F16C 33/44; F16C 2208/60; B29K 2077/00; F16C 19/06; B29L 2031/04; F16C 2223/00

(57) ABSTRACT

In a first process, a resin molded article having a predetermined shape is molded. Next, in a second process, a surface of the resin molded article is treated with plasma in a vacuum to provide irregularities in the surface of the resin molded articles. In the second process, discharge ignition is performed in inert gas to generate plasma, and while a degree of vacuum is maintained, raw material gas is then replaced by air.

### TECHNICAL FIELD

An aspect of the present invention relates to a resin member production method.

### BACKGROUND ART

In recent years, products made of resin have been used in various fields due to increasing strength of resin materials. For example, in a field of automobiles, to reduce weight of components for automobiles has been required due to demands for reduction of environmental loads. Thus, components made of metal have been replaced by components made of resin.

However, when a resin member is introduced into a part where lubricity is required, such as a sliding part, a gear, a bearing, etc., there arises a problem in wettability of oil. A resin member is inferior to a metal member as to wettability of lubricating oil. There is a case that the resin member cannot show sufficient lubricating performance. Therefore, various members processed to improve wettability of resin members with respect to oil or water have been proposed.

For example, Patent Document 1 discloses a worm wheel including a core made of metal, a resin portion formed integrally with an outer circumferential surface of the core and having gear teeth, and a hard carbon film formed in surfaces of the gear teeth by a plasma CVD method, a plasma ion implantation method, or the like.

For example, Patent Document 2 discloses a mechanical seal in a water pump, including a fixed ring and a rotary ring having sliding surfaces opposed to each other. A hydrophilic face portion is formed in each sliding surface by plasma irradiation, laser light, ultraviolet rays, etc.

### RELATED ART DOCUMENTS

### Patent Documents

Patent Document 1: JP-A-2004-155245

Patent Document 2: JP-A-2005-188651

### SUMMARY OF THE INVENTION

### Problem to be Solved by the Invention

Methods of surface treatment for resin members are chiefly classified into physical treatment and chemical treatment. The treatment methods disclosed in Patent Documents 1 and 2 belong to the former, that is, the physical treatment. The physical treatment is to process a surface of a member or form a film thereon to thereby change a physical property of the surface. The physical treatment is superior in sustainability (durability) of effects obtained by the treatment, and can be performed by a dry process. Therefore, the physical treatment delivers less burden on the environment than the chemical treatment such as treatment with a solvent. However, the physical treatment has not yet been established satisfactorily for complicated shapes other than planar shapes.

On the other hand, the chemical treatment is performed in a manner in which functional groups (—OH groups, —CH groups, etc.) are added to a surface (polymer surface) of a resin member by a solvent or gas. Therefore, the chemical treatment is satisfactorily effective for complicated shapes. However, adhesive force of the functional groups to the polymer surface is so weak that the surface is easily affected by external force or atmosphere. Thus, the chemical treatment is often inferior to the physical treatment as to durability. In addition, it is also concerned that burden on the environment may increase if the solvent is not handled properly.

It is therefore an object of one aspect of the invention is to provide a resin member production method in which liquid wettability sustained for a long time can be given to a resin molded article independently of the shape of the resin molded article, and burden on the environment is low.

### Means for Solving the Problem

According to one aspect of the invention, a method for manufacturing a resin member (1), including: a first process in which a resin molded article (2) having a predetermined shape is molded; and a second process in which a surface (3, 4, 5, 6) of the resin molded article is treated with plasma in a vacuum to provide irregularities in the surface of the resin molded article, wherein in the second process, discharge ignition is performed in inert gas is to generate plasma, and while a degree of vacuum is maintained, raw material gas is then replaced by air.

Incidentally, in the above-described paragraph, numbers etc. in parentheses designate reference signs of corresponding constituent elements in an embodiment which will be described later. However, these reference signs are not intended to limit the scope of the claims.

### Advantages of the Invention

According to one aspect of the invention, a surface of a resin molding article is brought into a high energy state due to charged particles ionized by plasma excitation in a vacuum. Thus, crystallinity of the surface can be improved to increase surface density. At the same time, surface roughness of the resin molding article can be increased by faint ion sputtering energy, so that a contact surface area of the resin molding article with liquid or droplets can be increased. As a result, it is possible to obtain an effect of improving wettability while securing excellent durability against external force such as frictional force. In addition, since the plasma treatment is performed in a vacuum, the charged particles are not released but can be diffused all over the resin molded article. Therefore, even if the shape of the resin molded article is a complicated shape including an interlacing surface such as an inner circumferential surface of a cylindrical member, respective surfaces of the member can be treated uniformly. Further, due to the dry process using plasma (physical treatment), the burden on the environment can be reduced.

### BRIEF DESCRIPTION OF THE DRAWINGS

FIG. 1 is a flow chart of a process for manufacturing a resin member according to an embodiment of the invention.

FIG. 2 is a schematic perspective view of a resin molded article for the resin member.

FIG. 3 is a schematic view of an apparatus for use in plasma treatment for the resin molded article.

FIG. 4 is a graph showing the relationship between a degree of vacuum and a discharge starting voltage for each raw material gas.

FIG. 5 is a timing chart of a pulse voltage.

FIG. 6 is a sectional view showing a rolling bearing according to the embodiment of the invention.

FIG. 7 is a flow chart (modification) of the process for manufacturing the resin member according to the embodiment of the invention.

FIG. 8 is a view for explaining a method for measuring hardness of a soft layer.

FIG. 9 is a view showing a state of solid contact in a case where the soft layer has been formed.

FIG. 10 is a graph for explaining an effect of reducing a frictional coefficient according to an example of the invention.

FIG. 11 is a graph for explaining an effect of improving wettability according to the example of the invention.

FIG. 12 is a graph showing a distribution of hardness in each depth from a surface of the resin member, and an amount of change of the hardness.

FIG. 13 is a view for explaining a method of a friction test.

FIG. 14 is a graph for explaining sustainability of the frictional coefficient.

FIG. 15 is a graph for explaining the effect of reducing the frictional coefficient.

### MODE FOR CARRYING OUT THE INVENTION

An embodiment of the invention will be described below in detail with reference to the accompanying drawings.

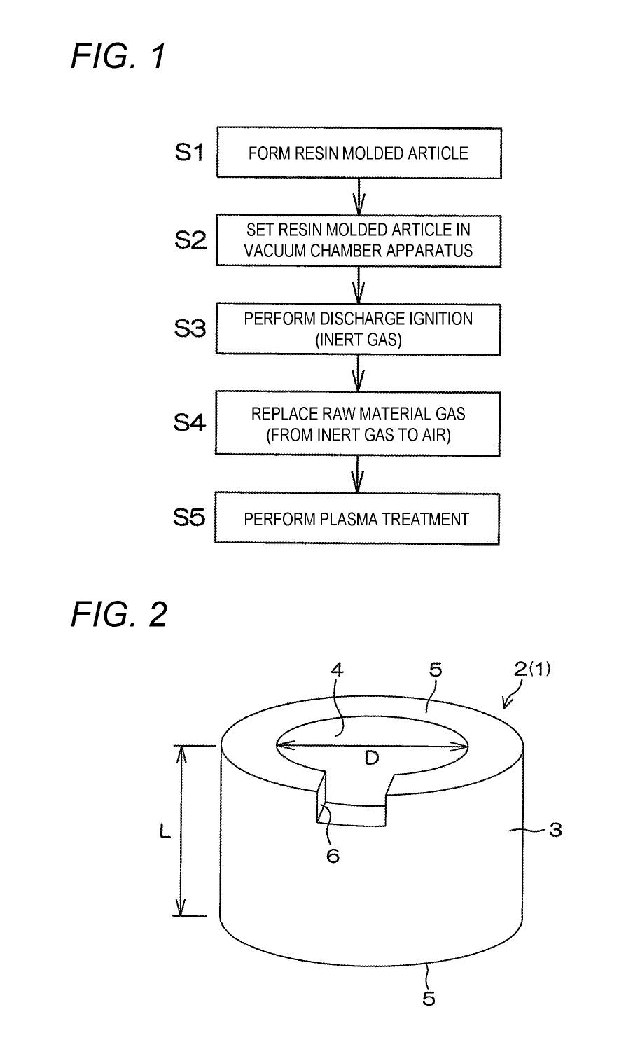

FIG. 1 is a flow chart of a process for manufacturing a resin member 1 according to the embodiment of the invention.

In order to manufacture the resin member 1, for example, a resin raw material is molded into a predetermined shape by a known molding method such as injection molding, extrusion molding, compression molding, etc., so as to form a resin molded article 2 serving as a body of the resin member 1 (Step S1).

Examples of the resin raw material used thus may include crystalline thermoplastic resins, and thermosetting resins. Examples of the crystalline thermoplastic resins may include polyamide (PA), polyacetal (POM), polyethylene terephthalate (PET), polybutylene terephthalate (PBT), polyphenylene sulfide (PPS), polyether ether ketone (PEEK), liquid crystal polymer (LCP), polytetrafluoroethylene (PTFE), etc. Examples of the thermosetting resins may include epoxy resin, phenol resin, unsaturated polyester resin, urea resin, melamine resin, diallyl phthalate resin, silicone resin, vinyl ester resin, polyimide resin, polyurethane resin, etc. The crystalline thermoplastic resins and the thermosetting resins are not limited to the above-described examples, but various ones may be used in conformation to the specification of the resin member 1.

FIG. 2 is a schematic perspective view of the resin molded article 2 for use in the resin member 1.

The resin molded article 2 forms a body of the resin member 1 for use in various applications. The resin molded article 2 is molded into a shape corresponding to the specification of the resin member 1. That is, the shape of the resin molded article 2 depicted in FIG. 2 is merely an example for explaining the embodiment of the invention.

Examples of the applications of the resin member 1 may include sliding members for vehicles such as a rolling bearing, a slide bearing, etc., gears made of resin, various painted materials which will be painted with water paint or oil paint when they are used, substrates which will be coated with various coating agents (moisture-proof coating, stain-proof coating, water repellent coating, etc.) when they are used, etc. However, the applications of the resin member 1 are not limited to the examples.

The resin molded article 2 includes a tubular member (a cylindrical member in the embodiment) with a predetermined thickness. For example, the resin molded article 2 has an outer circumferential surface 3, an inner circumferential surface 4, and end surfaces 5 and 5 of axially opposite end portions. A part of a thick portion of the resin molded article 2 is selectively eliminated from the end surface 5 in one of the axially opposite end portions, so as to form a cut portion 6. Length L of the resin molded article 2 may be, for example, 10 mm to 30 mm. In addition, an inner diameter D of the resin molded article 2 may be, for example, 5 mm (φ5) to 20 mm (φ20). In addition, heat resistant temperature of the resin molded article 2 may be, for example, 80° C. to 150° C.

Next, the resin molded article 2 is set in a vacuum chamber apparatus 7 (Step S2).

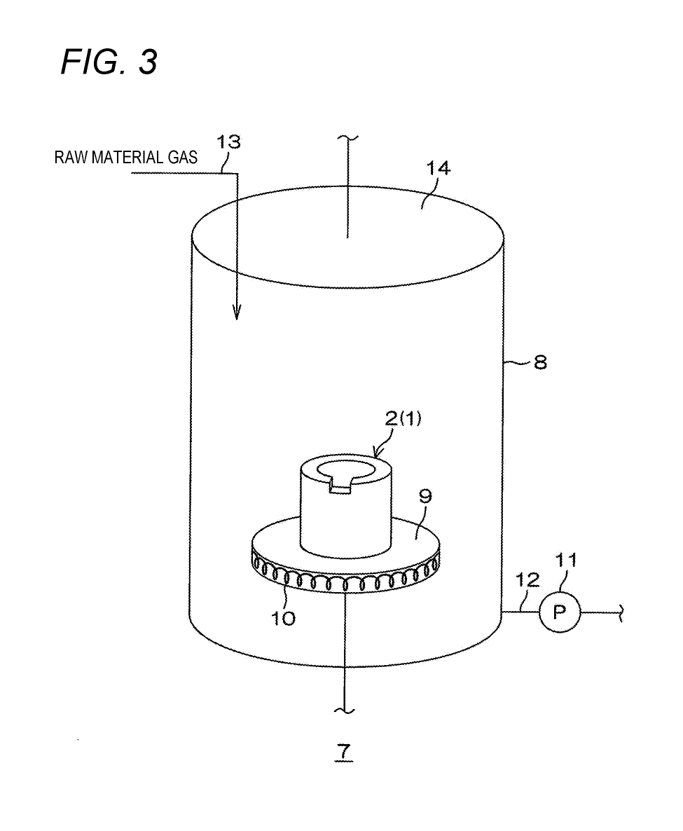

FIG. 3 is a schematic view of the vacuum chamber apparatus 7 for use in plasma treatment for the resin molded article 2.

A susceptor 9 is disposed in a lower portion of a chamber 8 in the vacuum chamber apparatus 7. A heater 10 is built in the susceptor 9. The resin molded article 2 is held by the susceptor 9 so that the resin molded article 2 can be heated to a predetermined temperature by the heater 10. In addition, an exhaust line 12 provided with a vacuum pump 11 in the middle thereof is connected to the lower portion of the chamber 8. The vacuum pump 11 is driven so that a predetermined degree of vacuum can be maintained inside the chamber 8. A pressure range of the vacuum used in the embodiment is, for example, 1×10⁻¹ Pa to 1×10⁻² Pa.

On the other hand, a raw material gas feed line 13 for feeding raw material gas into the chamber 8 is connected to a top portion of the chamber 8. Although only a raw material gas feed line 13 is depicted in FIG. 3, a plurality of raw material gas feed lines 13 may be provided when a plurality of kinds of raw material gases are fed. In addition, wiring is connected to a top portion 14 of the chamber 8 so that the top portion 14 opposed to the susceptor 9 can also serve as an electrode. A DC bias can be applied between the top portion 14 and the susceptor 9. A distance (inter-electrode distance) between the top portion 14 and the susceptor 9 is, for example, 80 mm to 400 mm.

After the resin molded article 2 is set in the susceptor 9, plasma treatment is started in the vacuum chamber apparatus 7.

First, the vacuum pump 11 is driven to discharge gas from the chamber 8 through the exhaust line 12, while raw material gas is fed from the raw material gas feed line 13.

In this initial stage, pressure inside the chamber 8 is kept at a medium vacuum of 40 Pa to 90 Pa, while inert gas is fed as the raw material gas. Then, a voltage is applied between the top portion 14 (electrode) of the chamber 8 and the susceptor 9 to induce discharge ignition (plasma excitation) in the inert gas (Step S3). Thus, the inert gas is made into plasma. The voltage applied at the time of the discharge ignition is, for example, 300 V to 600 V, or preferably 400 V to 500 V. When the applied voltage is lower than 300 V, it is difficult to induce plasma excitation. On the contrary, when the applied voltage is beyond 600 V, there is a fear that the treated surface (the outer circumferential surface 3, the inner circumferential surface 4, the end surfaces 5 and the cut portion 6) of the resin molded article 2 may be damaged due to a temperature rise of the resin molded article 2 on the susceptor 9, and sparks at the time of the ignition. In addition, the temperature of the heater 10 is, for example, 30° C. to 150° C.

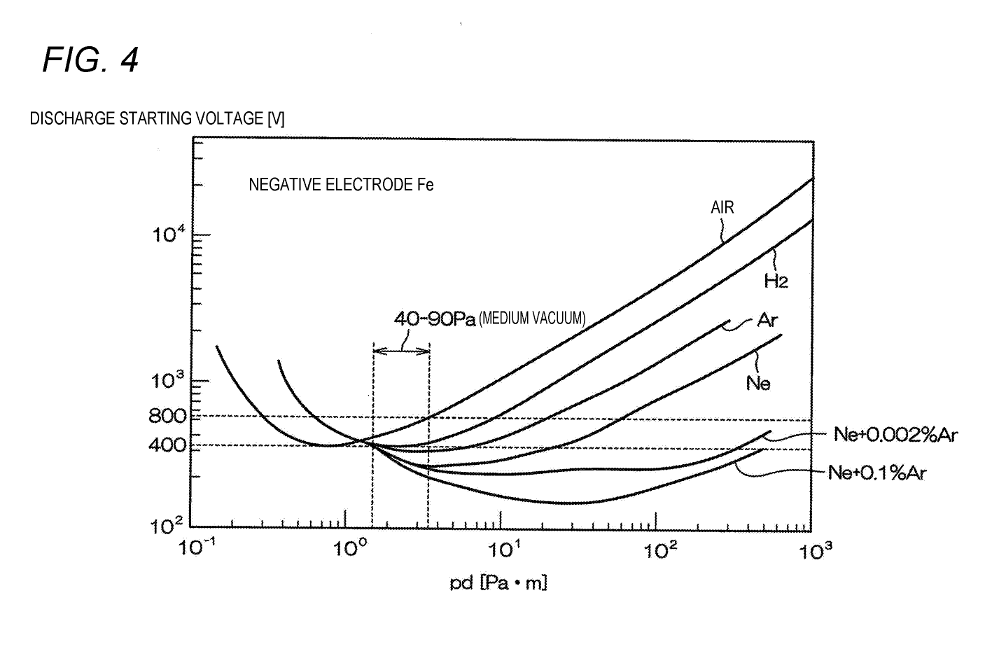

The reason why inert gas is fed as raw material gas in the initial stage (discharge ignition time) of the plasma treatment can be explained with reference to FIG. 4. As shown in FIG. 4, the discharge starting voltage of the air is 500 V to more than 600 V in a pressure range of a medium vacuum of 40 Pa to 90 Pa while the discharge starting voltage of inert gas (He, Ar) is about 400 V to 450V. Therefore, the pressure inside the chamber 8 reaches about several Pa in order to suppress the discharge starting voltage of the air within the preferable range (from 400 V to 500 V). Under such a low vacuum, there is a fear that gas may be released from the resin molded article 2 at the time of discharge ignition to thereby degrade the resin molded article 2. However, when inert gas is used as raw material gas for discharge ignition, discharge ignition can be performed satisfactorily under a medium vacuum. Incidentally, N₂ (nitrogen) may be used as the inert gas as well as noble gas such as He or Ar.

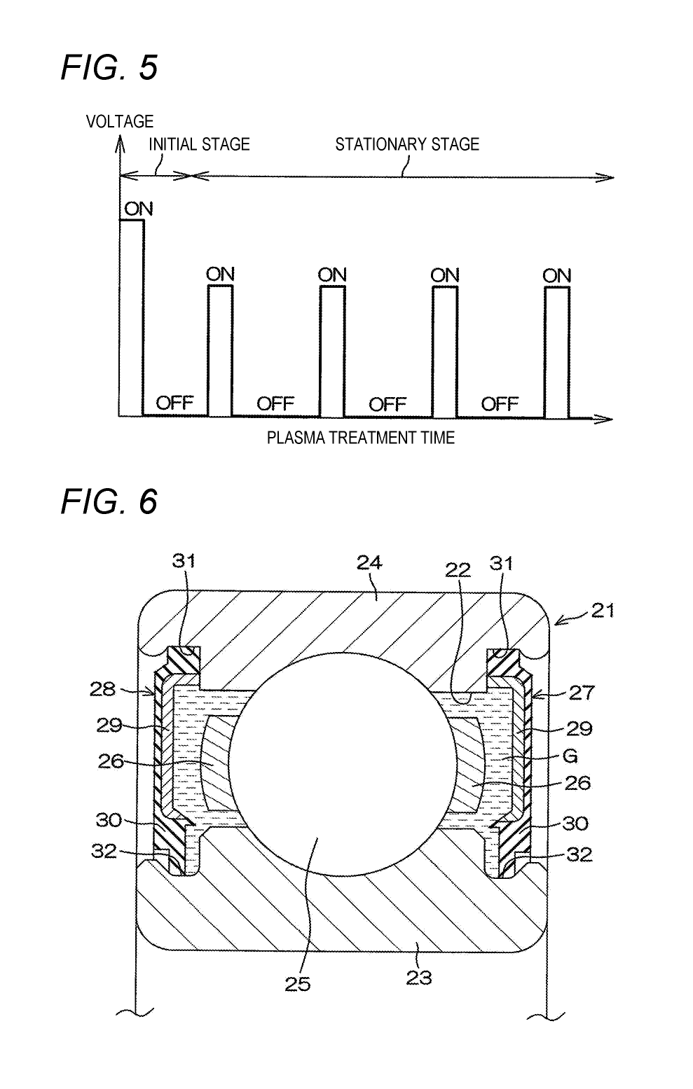

When the discharge ignition is completed, the treatment moves from the initial stage to a stationary stage. The plasma excitation state is maintained while the degree of vacuum inside the chamber 8 is kept in a medium vacuum, and the raw material gas is replaced from the inert gas by the air (Step S4). After that, as shown in FIG. 5, on/off control is performed on a voltage lower than the discharge starting voltage so as to apply a pulse voltage between the top portion 14 of the chamber 8 and the susceptor 9. Thus, the air is made into plasma (non-equilibrium plasma), and plasma treatment is performed on the resin molded article 2 with charged particles ionized thus (Step S5). Incidentally, in the stationary stage, the inside of the chamber 8 is in a state where plasma occurs continuously due to transition from the initial stage. Therefore, the air can be made into plasma by a comparatively low voltage even under the medium vacuum.

The duration (plasma treatment time) of the stationary stage is, for example, 10 minutes to 15 minutes. When the plasma treatment time is shorter than 10 minutes, it is difficult to obtain a satisfactory treatment effect. On the contrary, when the plasma treatment time is beyond 15 minutes, there is a fear that temperature or surface roughness of the resin molded article 2 may increase excessively. In the plasma treatment time ranging thus, pulse width of the pulse voltage is, for example, 0.2 milliseconds to 1 millisecond, or preferably 0.2 milliseconds to 0.25 milliseconds. In addition, pulse frequency is, for example, 0.1 kHz to 0.5 kHz, or preferably 0.4 kHz to 0.5 kHz. When the pulse frequency is lower than 0.1 kHz, it is difficult to obtain a satisfactory treatment effect. On the contrary, when the pulse frequency is beyond 0.5 kHz, there is a fear that the temperature of the resin molded article 2 may increase excessively. In addition, the temperature of the heater 10 in the stationary stage is, for example, 60° C. to 120° C.

After the plasma treatment, the resin molded article 2 is extracted from the chamber 8. Thus, the resin member 1 can be obtained.

According to the above-described method, the surface (the outer circumferential surface 3, the inner circumferential surface 4, the end surfaces 5 and the cut portion 6) of the resin molded article 2 is brought into a high energy state by charged particles ionized from O₂, CO₂, H₂O, etc. constituting the air. Thus, the crystallinity of the surface of the resin molded article 2 can be improved, and the surface density can be increased. At the same time, the surface roughness of the resin molding article 2 can be increased by faint ion sputtering energy, so that the contact surface area of the resin molding article 2 with liquid or droplets can be increased. As a result, it is possible to obtain an effect of improving wettability while securing excellent durability against external force such as frictional force. For example, the contact angle of the surface of the resin molded article 2 with the liquid can be made smaller than 70% of that prior to the plasma treatment.

In addition, since the plasma treatment is performed in a vacuum, the charged particles are not released but can be diffused all over the resin molded article 2. The treatment can be performed uniformly even in a complicated hollow part such as the inner circumferential surface 4 or the cut portion 6 of the resin molded article 2. Further, due to the dry process using plasma (physical treatment), the burden on the environment can be reduced.

In addition, the resin molded article 2 made of a high polymer material chiefly consisting of C (carbon atoms), H (hydrogen atoms) and O (oxygen atoms) is treated with plasma using the air (including O₂, CO₂ and H₂O). Therefore, lipophilic functional groups (—CH groups) or hydrophilic functional groups (—OH groups) can be added to the surface of the resin molded article 2 during the plasma treatment.

Further, a continuous voltage is not applied between the top portion 14 of the chamber 8 and the susceptor 9, but a pulse voltage is applied therebetween, while non-equilibrium plasma (low-temperature plasma) is generated in the chamber 8. It is therefore possible to suppress temperature rise in a plasma atmosphere. Thus, the treatment can be applied to the resin molded article 2 satisfactorily even if its heat resistance is not high.

In this manner, in a case where the resin member 1 is used as a sliding member, the contact angle of lubricating oil can be reduced when the sliding member slides under lubrication of the oil. Thus, a small amount of the lubricating oil can be spread over a sliding face of the resin member 1 to thereby make the sliding face wet therewith. As a result, the amount of the lubricating oil can be reduced to reduce the resistance of the lubricating oil to stirring. Thus, it is, for example, possible to reduce bearing torque.

In a case where the resin member 1 is used as a painted material or a substrate, the contact angle of a paint or a coating agent can be reduced to improve adhesive force thereof.

Next, a mode in which the resin member 1 subjected to plasma treatment as described above is used as a cage of a rolling bearing will be described with reference to FIG. 6.

FIG. 6 is a sectional view showing a rolling bearing 21 according to the embodiment of the invention.

The rolling bearing 21 has an inner ring 23, an outer ring 24, a plurality of balls 25, a cage 26. grease G, and a pair of annular seal members 27 and 28. The inner ring 23 and the outer ring 24 serve as a pair of raceway members defining an annular region 22 therebetween. The balls 25 are disposed in the region 22 so as to serve as rolling elements rolling with respect to the inner ring 23 and the outer ring 24. The cage 26 is disposed in the region 22 so as to retain the balls 25. The region 22 is filled with the grease G. The seal members 27 and 28 are fixed to the outer ring 24 so as to slide on and abut against the inner ring 23.

The seal members 27 and 28 include annular core metals 29 and 29, and annular rubber bodies 30 and 30 respectively. The rubber bodies 30 and 30 are baked to adhere onto the core metals 29 and 29 respectively. Outer circumferential portions of the seal members 27 and 28 are fitted and fixed to groove portions 31 and 31 formed in opposite end surfaces of the outer ring 24 respectively. Inner circumferential portions of the seal members 27 and 28 are fitted and fixed to groove portions 32 and 32 formed in opposite end surfaces of the inner ring 23 respectively.

The grease G is charged into the region 22 defined by the pair of seal members 27 and 28 between the two rings 23 and 24 so that the region 22 can be substantially filled up with the grease G.

According to this configuration, the grease G can be spread over the sliding surface of the cage 26 so as to make the sling surface wet therewith. Accordingly, the amount of the grease G can be reduced to reduce the resistance of the grease G to stirring. Thus, it is possible to reduce bearing torque of the rolling bearing 21.

The invention is not limited to the above-described embodiment, but it can be carried out in another embodiment.

For example, the raw material gases used in the initial stage and the stationary stage are not limited to the inert gas and the air respectively, but other gases may be used as long as they can express the effects of the invention.

In addition, when the plasma treatment is performed on the resin molded article 2 having high heat resistance, thermal plasma can be used in place of the non-equilibrium plasma, and it is unnecessary to generate plasma by pulse discharge. For example, plasma may be generated by RF (Radio Frequency) discharge.

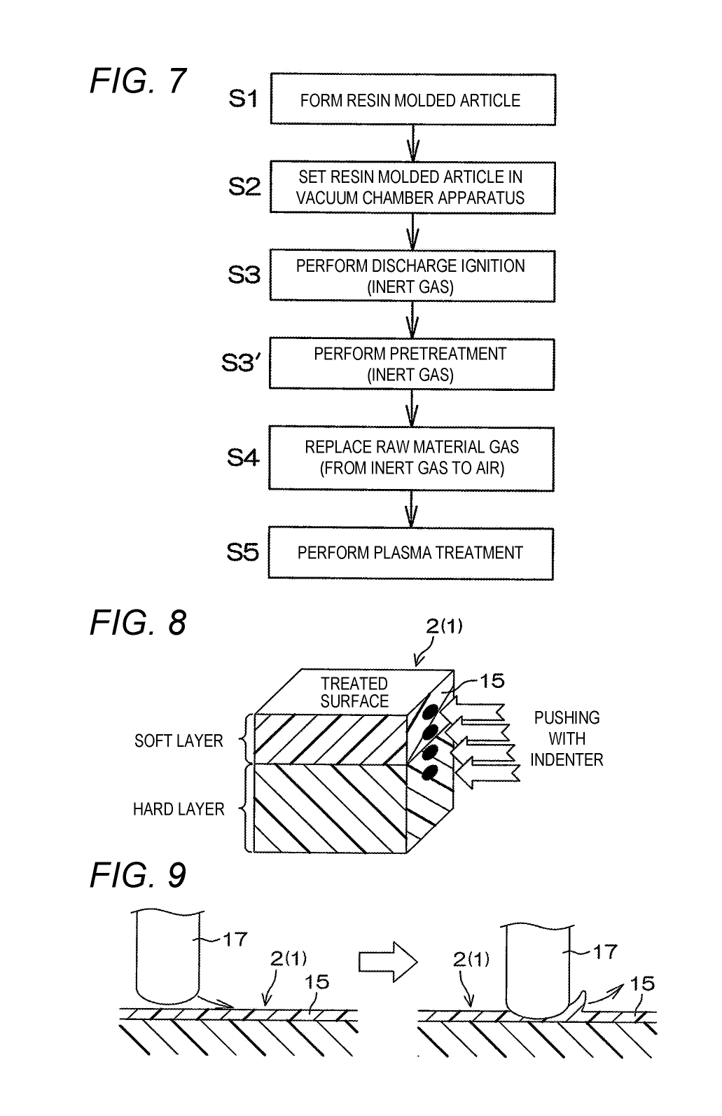

In addition, in the above-described embodiment, as shown in FIG. 1, immediately after discharge ignition is performed by inert gas (Step S3), the raw material gas is replaced from the inert gas by the air (Step S4). However, as shown in Step S3′ in FIG. 7, the resin molded article 2 may be pretreated with plasma of the inert gas prior to replacement of the raw material gas to thereby form a soft layer 15 (see FIG. 8). More specifically, a plasma state of insert gas is continued for a predetermined time after discharge ignition is performed by the inert gas. Thus, the ionized inert gas is accelerated to collide with a target (not shown), and materials sputtered from the target collide with the resin molded article 2. In this manner, sputtering is performed by the inert gas so that polymer chains in the surface of the resin molded article 2 can be broken (degraded faintly) to form the soft layer 15 at the broken places.

As the inert gas to be used for the pretreatment, the inert gas used for discharge ignition may be used as it is. Alternatively, the inert gas used for discharge ignition may be changed to another inert gas to be used for the pretreatment.

The time of the pretreatment may be, for example, 300 seconds to 600 seconds. When the time of the pretreatment is shorter than 300 seconds, the polymer chains in the surface of the resin molded article 2 may be not broken satisfactorily. On the contrary, when the pretreatment is performed for a long time beyond 600 seconds, excessive deterioration may occur in the surface of the resin molded article 2.

The soft layer 15 formed thus is, for example, formed in a range of less than 50 μm (or from 0 μm to 20 μm) from the surface (treated surface) of the resin molded article 2. The hardness of the soft layer 15 is, for example, reduced by at least 40% in comparison with that of the untreated part (hard layer not subjected to the sputtering treatment) of the resin molded article 2. Specifically, the hardness of the soft layer 15 may be, for example, 0.05 GPa to 0.13 GPa when the hardness at a time of 400 to 600 nm pushing is measured by a thin film hardness meter (with a pushing load of 1000 μN). The measurement by the thin film hardness meter may be performed as follows. That is, as shown in FIG. 8, the resin molded article 2 subjected to the treatment is cut off. An indenter of the thin film hardness meter is then pushed to a cut-off section of the resin molded article 2 sequentially in some places in a depth direction from the treated surface.

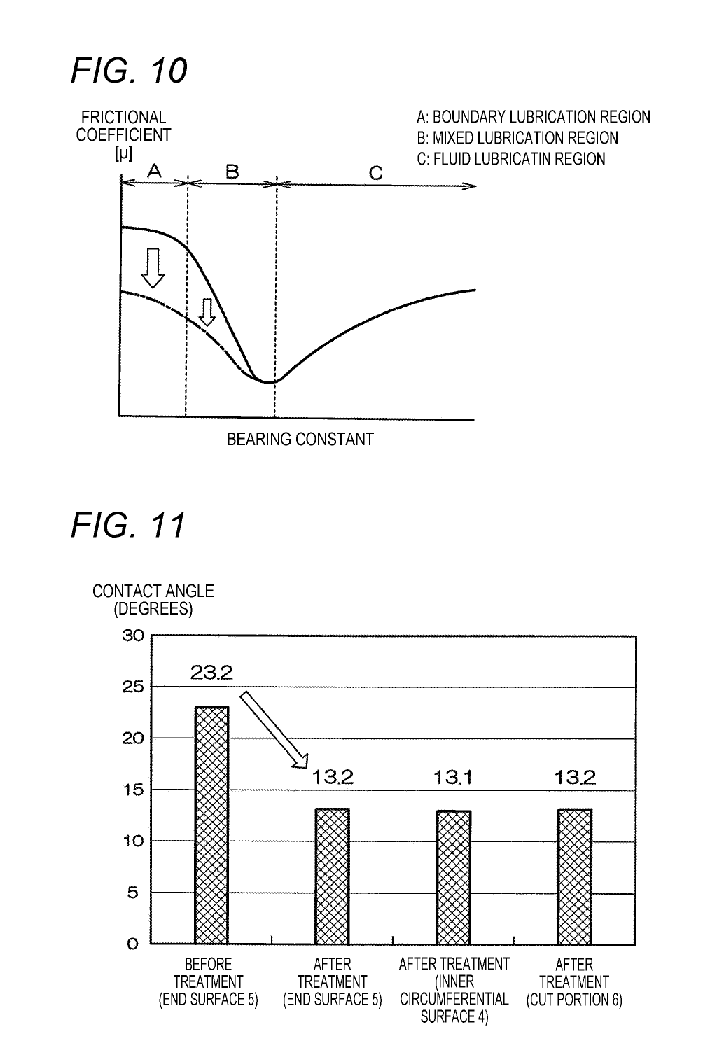

Solid contact may occur between the resin member 1 (resin molded article 2) and a partner-side member 17 because the amount of lubricating oil is temporarily reduced between the resin member 1 and the partner-side member 17. Even in such a case, when the soft layer 15 is formed, impact caused by the contact with the partner-side member 17 can be received and buffered by the soft layer 15 while sliding thereon, as shown in FIG. 9. As a result, a frictional coefficient between the resin member 1 and the partner-side member 17 can be kept low for a long time. It is therefore possible to improve seizure resistance of the resin member 1. That is, according to this modification, as shown in FIG. 10, it is possible to obtain an effect of not only reducing a frictional coefficient μ in a mixed lubrication region B due to the plasma treatment with the air (alternate long and short dashes line), but also reducing the frictional coefficient μ in a boundary lubrication region A due to control of the hardness of the surface layer of the resin member 1 (alternate long and two short dashed line). Due to the reduction of friction, an inexpensive material having a comparatively low heatproof temperature can be used as the material of the resin member 1.

In addition, various design changes can be made within the scope stated in the claims.

### EXAMPLES

Next, the invention will be described along examples thereof. However, the invention is not limited to the following examples.

### Example 1

First, a sample to be treated (molded article) was produced based on FIG. 2. The sample was produced in the following conditions.

resin material: PA (polyamide) 66

length L: 25 mm

inner diameter D: φ15

Next, plasma treatment was performed on the obtained sample to be treated, according to the above-described method. Incidentally, as for raw material gases, Ar was used in the initial stage, and the air was used in the stationary stage.

As a result of the treatment, a structure of meshes with intervals of 50 μm to 200 μm was provided in a surface of the sample to be treated. It could be confirmed that the structure of meshes had a configuration in which convex portions were 0.1 μm to 3.0 μm high from the surface. Incidentally, the intervals of the meshes or the heights of the convex portions in the structure were confirmed based on a scale of an image photographed and obtained from the plasma-treated surface of the sample by a scanning electron microscope (SEM). It was proved that the surface area of the sample was increased by the structure of the meshes so that the contact angle of liquid could be reduced by the following Expression (1) known as Wenzel equation.

cos θ_{γ}=γ cos θ (1)

(In Expression (1), θ_{γ} designates a contact angle after roughening, θ designates a contact angle on a plane, and γ designates a surface area multiplication factor.)

Next, additive-free mineral oil was dripped onto the plasma-treated surface of the sample to evaluate wettability thereof. FIG. 11 shows the result. From FIG. 11, it was proved that the contact angle of the mineral oil could be reduced to less than 70% of that before the plasma treatment at any place of the resin molded article 2.

### Example 2

A resin plate made of PA (polyamide) 66 was prepared, and plasma treatment was performed thereon according to the above-described method. Incidentally, as for raw material gases, Ar was used in the initial stage, and the air was used in the stationary stage. Further, in the initial stage, a plasma state of Ar gas was continued for 300 seconds to perform sputtering treatment (pretreatment) on a surface of the resin plate.

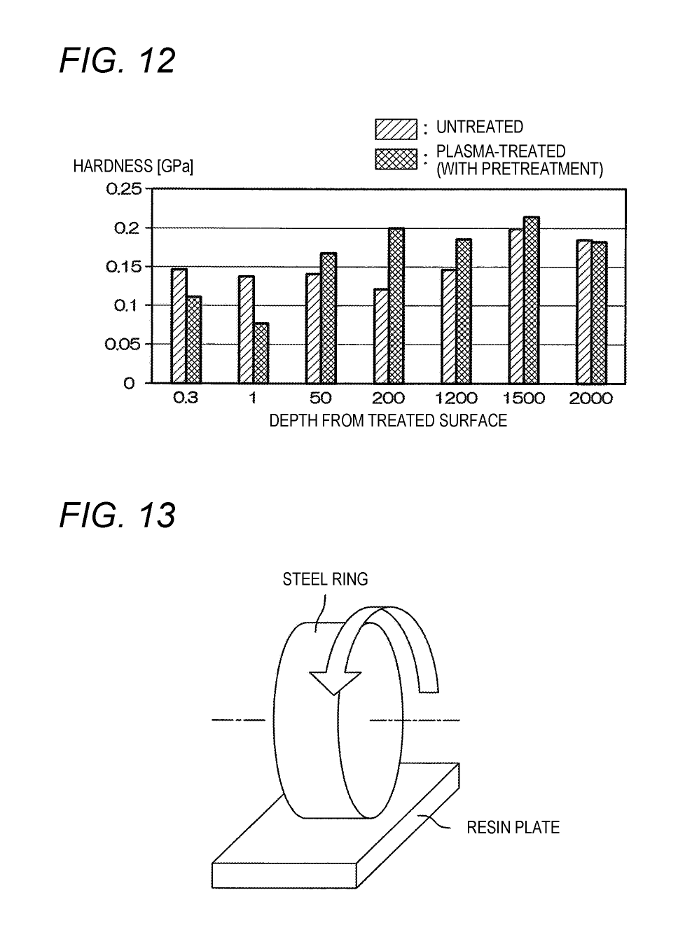

Next, hardness in each of positions 0.3 μm, 1 μm, 50 μm, 200 μm, 1200 μm, 1500 μm and 2000 μm deep from the treated surface of the resin plate was measured by a thin film hardness meter (with a pushing load of 1000 μN) according to the method shown in FIG. 8. FIG. 12 shows the result. From FIG. 12, it was proved that a soft layer whose hardness had been made smaller than that before the plasma treatment was formed at least in the positions 0.3 μm and 1 μm deep. On the other hand, in the positions 50 μm to 1500 μm deep, the hardness was higher than that before the plasma treatment. It could be considered that some energy (minute vibration, thermal energy, etc.) was applied to the resin plate due to sputtering treatment or the like, and the resin was consequently recrystallized (recondensed) just under the soft layer.

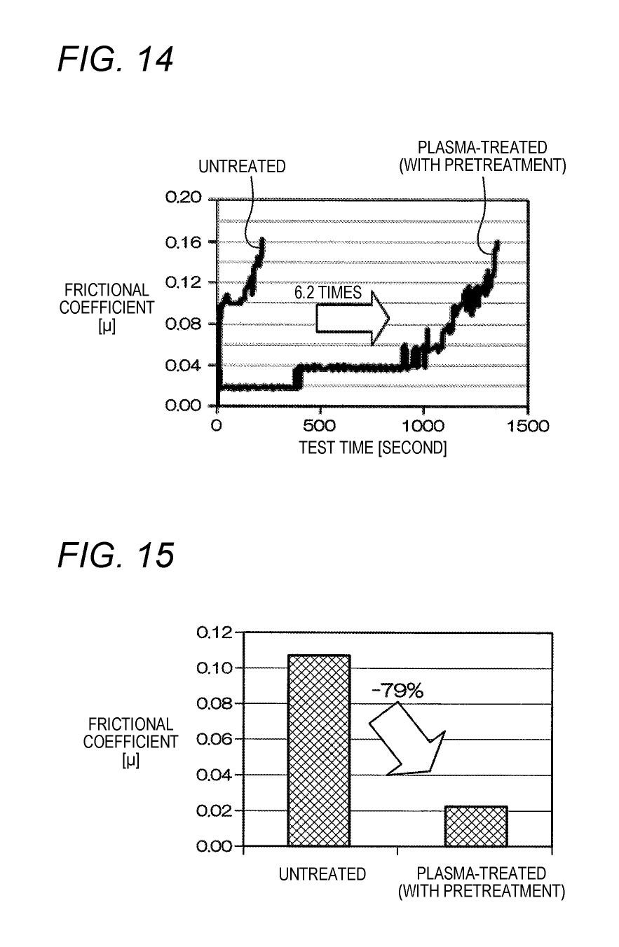

Next, a friction test was performed on the resin plate subjected to the plasma treatment. The friction test was performed by bringing a steel ring as a partner-side member into contact with the resin plate through lubricating oil (additive-free mineral oil 0.02 ml) as shown in FIG. 13. As for conditions of the friction test, a load was set at 50 N (surface pressure: 11.4 MPa), and a rate was set at 5500 mm/s. FIGS. 14 and 15 show the result. FIG. 14 is a graph for explaining sustainability of the frictional coefficient. On the other hand, FIG. 15 is a graph for explaining the effect of reducing the frictional coefficient.

As shown in FIG. 14, it was proved that the sustainability of the frictional coefficient after the plasma treatment of Example 2 was performed was improved to be about 6.2 times as high as that in a case where the treatment was not performed. In addition, as shown in FIG. 15, it was proved that the initial value of the frictional coefficient was reduced by about 79% in comparison with that in the case where the treatment was not performed.

The present application is based on a Japanese patent application (Japanese Patent Application No. 2014-260519) filed on Dec. 24, 2014, and a Japanese patent application (Japanese Patent Application No. 2015-204837) filed on Oct. 16, 2015, and the contents of which are incorporated herein by reference.

### DESCRIPTION OF REFERENCE SIGNS

1 . . . resin member, 2 . . . resin molded article, 3 . . . outer circumferential surface, 4 . . . inner circumferential surface, 5 . . . end surface, 15 . . . soft layer, 26 . . . cage

1. A resin member production method, comprising:
a first process in which a resin molded article having a predetermined shape is molded; and
a second process in which a surface of the resin molded article is treated with plasma in a vacuum to thereby provide irregularities in the surface of the resin molded article,
wherein in the second process, discharge ignition is performed in inert gas to generate plasma, and while a degree of vacuum is maintained, raw material gas is then replaced by air.

2. The resin member production method according to claim 1,
wherein the resin molded article is treated with non-equilibrium plasma in the second process.

3. The resin member production method according to claim 2,
wherein the second process comprises a process in which the non-equilibrium plasma is generated by pulse discharge.

4. The resin member production method according to claim 1,
wherein the resin molded article is treated with plasma using air in the second process.

5. The resin member production method according to claim 1,
wherein the second process comprises a process in which the resin molded article is pretreated with plasma of the inert gas for a predetermined time to form a soft layer in the surface of the resin molded article.

6. The resin member production method according to claim 5,
wherein pretreatment with the plasma of the inert gas is performed for 300 to 600 seconds.

7. The resin member production method according to claim 5,
wherein hardness of the soft layer is 0.05 GPa to 0.13 GPa when the hardness at a time of 400 nm to 600 nm pushing is measured by a thin film hardness meter in which a pushing load has been set at 1000 μN.

8. The resin member production method according to claim 1,
wherein the resin molded article comprises a molded article for a sliding member.
